(19) United States
(12) Patent Application Publication
(10) Pub. No.: US 2007/0061449 A1
(43) Pub. Date: Mar. 15, 2007

(54) Identification of communication channels

(75) Inventor: Karina Nitsch, Potsdam (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/520,828

(22) Filed: Sep. 13, 2006

(30) Foreign Application Priority Data
Sep. 13, 2005 (EP) 05019888.6 EP

(51) Int. Cl. G06F 15/173

(52) U.S. Cl. 709/224; 709/217; 709/223

(57) ABSTRACT

A technology-independent scheme is defmed for channels of a communication network which are already identified by first identifiers constituting a technological identification scheme. According to this second scheme, the channels are assigned second, technology-independent identifiers by which the channels are identified.

### CROSS REFERENCE TO RELATED APPLICATIONS

This application claims priority of European application No. 05019888.6 EP filed Sep. 13, 2005, which is incorporated by reference herein in its entirety.

### FIELD OF INVENTION

The present invention relates to the identification of communication channels in a communications network.

### BACKGROUND OF INVENTION

ITU-T international standard M.3010 (02/2000) describes a reference architecture of a Telecommunications Management Network (TMN) for monitoring and controlling a communications network, proceeding from the assumption that the network controlled by the TMN comprises different types of network elements which are controlled using suitable communications mechanisms. These mechanisms are e.g. protocols with rules for exchanging management information. The exchange is effected e.g. using indications or messages. The information is also termed object model.

The TMN incorporates, among others, the following functionalities:
Operations Systems Function (OSF), which implements the “actual” management of the telecommunications network.
Workstation Function (WSF), which is used for visually displaying the control processes and network status.
Network Element Function (NEF), which constitutes an interface for controlling the telecommunications functions of the network elements. The interface defines the relevant network element's specific communications mechanism which is usually not internationally standardized. The sum of all the management information of the NE is termed the Management Information Base (MIB) of the NE. It will also be referred to hereinafter as NE-MIB.
Transformation Function (TF), which is used to link components with different communications mechanisms and in particular to connect network elements to the TMN which do not have an NEF compatible with an international standard. It is also referred to in standard M.3010 (05/96) as Mediation Function or as Q-Adaption Function.

In addition, the functionalities are classified as far as possible into the following groups according to the FCAPS scheme:
F=Fault
C=Configuration
A=Accounting
P=Performance
S=Security

The functions are effected by material products which may be embodied, for example, as a network element (NE), operations system (OS), application, terminal, router, switch, database server or computer program product (also referred to as program, applications or software), but are not, of course, limited thereto.

The NEF function is usually assigned to an NE, whereas the OSF and WSF functions are mostly assigned to an OS. Typically, an OS is assigned a plurality of NEs, the OS usually being centralized, whereas the NEs are distributed on a de-centralized basis in the network over a plurality of locations.

An OS can comprise a number of programs. The programs can be embodied for example as management applications for controlling different network technologies of a communications network, of which an application-specific subset of the network's resources that is relevant to the technology controlled is modeled, visualized and controlled.

The programs are executed by hardware (e.g. processor, I/O module) which is provided in the material products. Said execution is supported by support software (e.g. multitasking or multithreading operating system, database system, Windows system).

The individual functionalities can be performed by integrated products implemented and sold by a manufacturer or by a system of a plurality of products implemented and sold by different manufacturers, in the latter case the products each performing part of the total functionality and interacting in such a way that, overall, the same functionality is implemented as with an integrated implementation of the functionalities.

These products can be embodied as computer program products which are executed by hardware (e.g. at least one processor) which constitutes the material execution environment of the products. Said execution is frequently supported by support software (e.g. multitasking or multithreading operating system, database system, Windows system).

### DETAILED DESCRIPTION OF INVENTION

In communications networks a plurality of communications channels is normally provided. For controlling such a network, channel identification technology is required so that the individual channels can be selectively addressed and controlled. Specifying an identification technology is difficult, as no uniform standard has yet emerged.

All in all, because of the distributedness of the system and the large number of different functionalities, system components and requirements, translating the described architecture into specific solutions is a highly complex technical problem.

The object of the invention is to identify at least one of the existing problems and to solve same by specifying at least one teaching for technical action.

The invention is based on the following insights:
Because of the progressive integration of electrical and optical components, the number of communications channels encompassed by individual network elements is ever-increasing.
At the same time, modern display technologies are characterized by ever larger and higher-resolution screens and faster image processing processors, so that the amount of displayable and displayed information is increasing.
The combined effect of this is that more and more channels are displayed simultaneously in the workstation functions of the network management systems.
This creates the new need, as recognized by the invention, for an identification technology for the communications channels which still remains clear even when a very large number of channels are displayed simultaneously.
The known identification technologies are geared to controlled communications technology and not to the question of their clarity in the case of large numbers of units. Rethinking and breaking away from this paradigm is unknown. However, this is precisely what is required here.
Simple identification of the channels is therefore becoming a complex and difficult task particularly for larger networks and screens.

The known techniques do not solve the recognized problems or at the very least have undesirable side effects:
In systems such as PCM30 (pulse code modulation with 30 user channels and two signaling channels) in which the channels are implemented using time slots which depend on their relative position within a frame, identification by position number is known, the absolute number of the positions being used for identifying the channels, i.e. the 30 user channels have the numbers 1-15 and 17-32 because the channels with positions 0 and 16 are used for signaling.
WDM systems operate for technological and/or configurational reasons in different frequency ranges/bands (e.g. red or blue, C or L band), with different frequency grids (e.g. 33, 50, 100, 200 GHz grid), with different numbers of channels (e.g. 8, 16, 40, 80), and/or with different frequency groups and gaps between frequency groups. In optical systems of this kind or generally in systems which are heavily frequency and wavelength dependent, identification via channel frequencies (e.g. 195400 GHz/195450 GHz/etc.) or via wavelengths (e.g. 1541.35 nm/1541.74 nm/etc.) is the rule. In the case of control operations across network elements, such as routing of optical paths or setting up services, compatibility and unambiguousness between the different systems is ensured using these values.
Although the identification of a channel via the frequency or wavelength is unambiguous across the systems, it is difficult for the operator to handle when working with the system on a daily basis, especially when six-digit complex numerical values are involved which are hard to memorize and with which it is difficult to communicate.

A solution for the inventively identified problem situation and advantageous embodiments of this solution are set forth in the claims which likewise serve to describe the invention and are therefore part of the description.

The invention will now be described using exemplary embodiments. It must be emphasized that these embodiments of the invention are merely exemplary in nature and are not to be taken in a limiting sense even when an embodiment of the invention is described in a highly detailed manner.

Products for carrying out the invention can be implemented as computer program products. To simplify the description of the invention it will be assumed that each computer program product corresponds unambiguously to a particular file. However, it will be clear to the average person skilled in the art that this limitation is not necessarily the case and a computer program product can at any time also include a plurality of files.

According to one embodiment of the invention it is proposed, in place of or in addition to a first, technology-dependent identification scheme for channel identification, e.g. via frequency or wavelength, to provide a second, technology-independent scheme for channel identification, e.g. channel numbering and/or naming. This is preferably perfomed in the network management system. Operator-specific requirements in respect of the numbering and/or naming scheme as well as the conditions described at the outset are taken into account.

According to one embodiment, a plurality of possible/conceivable numbering or naming schemes with which numbers and/or names can be assigned to the channel frequencies or wavelengths are stored.

According to another embodiment, the scheme or schemes are stored in the network element. The stored schemes are made available via a data interface to a management system for managing the network element. The scheme which is to apply to each network element can be selected and stored in the network element via the management interface. In addition, it is possible, via the management interface, to edit the stored schemes and to add further individual schemes.

A network management system can retrieve from the network element or store in the network element the scheme which is to be used for that network element.

The network management system uses the scheme defined for channel identification either in addition to frequency/wavelength or instead of same.

Example of a Numbering Scheme:

| Channel frequency/GHz | Channel wavelength/nm | Number |
|---|---|---|
| 192350 | 1558.57 | 76 |
| 192300 | 1558.98 | 77 |
| 192250 | 1559.39 | 78 |
| 192200 | 1559.79 | 79 |
| 192150 | 1560.20 | 80 |
| 192100 | 1560.60 | 81 |
| 192050 | 1561.01 | 82 |
| 192000 | 1561.42 | 83 |

Example of a Naming Scheme:

| Channel | Channel | |
|---|---|---|
| frequency/GHz | wavelength/nm | Name |
| 192350 | 1558.57 | Tulip |
| 192300 | 1558.98 | Rose |
| 192250 | 1559.39 | Jasmine |
| 192200 | 1559.79 | Lavender |
| 192150 | 1560.20 | Lily |
| 192100 | 1560.60 | Narcissus |
| 192050 | 1561.01 | Coneflower |
| 192000 | 1561.42 | Violet |

The invention describes the definition and selection of schemes to be used for a network element as a whole. Implementation in finer granularity is also possible, by which is meant the definition and selection of schemes analogously for each network element sub-unit, e.g. for each rack, subrack, shelf, card, etc.

The invention is not limited to WDM technology, but can also be applied to network elements of any technology necessitating identification of a frequency or wavelength.

A large number of further advantages are associated with the invention:
The identification of the channels has a high degree of flexibility, as the following can be optionally selected:
   a) Non-use of additional/alternative channel identification for all/individual network elements (or their sub-units);
   b) Use of different additional/alternative channel identifications for network elements or for groups of network elements (or their sub-units);
   c) Uniform network-wide additional/alternative channel identification.
Existing manual operations are shortened and operating errors are reduced or avoided altogether by the improved, ergonomic channel identification.
Implementation in network management that is free of network-element-dependent peculiarities such as frequency ranges, bands, grids, number of channels, frequency groups and/or gaps, configuration and/or technology.
Implementation of the invention requires no essential change to the prior art, but can basically be inserted subsequently as a module—in particular as a modified or additional computer program product..
The time of implementation is independent of the time of implementation of other functions.
The invention ensures that the individual components of the overall system are only minimally loaded, thereby increasing the stability of the overall system.

In conclusion, it should be pointed out that the description of the system components relevant to the invention are basically not to be taken in a limiting sense in respect of a particular physical implementation or assignment. To the average person skilled in the art it will be particularly obvious that the invention can be realized partially or completely in software and distributed over a plurality of physical products and, in particular, computer program products.

1.-10. (canceled)

11. A method for identifying channels of a communications network, the channels having a first identifier comprising a technology-dependent identification scheme that includes sinusoidal information, the method comprising:
defining a second identifier having a technology-independent scheme;
assigning the second identifier to each channel; and
identifying the channels with the via of the second identifier.

12. The method as claimed in claim 11, wherein the channels are encompassed by a material unit of the communications network and the second scheme is stored in a local database assigned to the unit.

13. The method as claimed in claim 12, wherein the second scheme which applies to the unit is selected and stored in the local database.

14. The method as claimed in claim 1 1, wherein a plurality of second schemes are defined.

15. The method as claimed in claim 1 1, wherein a selected second scheme is used for identification.

16. The method as claimed in claim 1 1, wherein the channels are identified using the first and the second identifiers.

17. A product incorporating means that are contrived to completely carry out the above method.

18. The product as claimed in claim 17, implemented as a material unit of a communications network, comprising at least one second scheme which is used for carrying out the method comprising:
defining a second identifier having a technology-independent scheme;
assigning the second identifier to each channel; and
identifying the channels with the via of the second identifier

19. A computer program identifying channels of a communications network, the channels having a first identifier comprising a technology-dependent identification scheme that includes sinusoidal information, the program stored on a processor unit readable medium and having instructions that are executable on the processor unit, the program when executed by the processor unit performs a method comprising:
defining a second identifier having a technology-independent scheme;
assigning the second identifier to each channel; and
identifying the channels with the via of the second identifier.

20. The program as claimed in claim 19, wherein the channels are encompassed by a material unit of the communications network and the second scheme is stored in a local database assigned to the unit.

21. The program as claimed in claim 20, wherein the second scheme which applies to the unit is selected and stored in the local database.

22. The program as claimed in claim 21, wherein a plurality of second schemes are defined.

23. The program as claimed in claim 22, wherein the channels are identified using the first and the second identifiers.
